(19) United States
(12) Patent Application Publication
(10) Pub. No.: US 2018/0295395 A1
(43) Pub. Date: Oct. 11, 2018

(54) METHOD FOR SPLICING VIDEO CONTENT INTO LIVESTREAMS

(71) Applicant: Hubtag, LLC, Seattle, WA (US)

(72) Inventor: Andrew Jamisson Story, Seattle, WA (US)

(21) Appl. No.: 15/786,545

(22) Filed: Oct. 17, 2017

Related U.S. Application Data
(60) Provisional application No. 62/409,253, filed on Oct. 17, 2016.

(51) Int. Cl. H04N 21/234; H04N 21/44; H04N 21/81

(52) U.S. Cl. CPC H04N 21/23424; H04N 21/6437; H04N 21/812; H04N 21/44016

(57) ABSTRACT

Embodiments of the invention relate to methods of combining live video streams with either live or static video streams in real time with little to no impact on quality and minimal impact on latency. Using a preferred embodiment of the invention, a user can splice video content directly into a livestream without the need for transcoding. One method comprises the steps of splicing video content from at least one source into a single output stream without transcoding the video content in real-time; detecting at least one stream outage; addressing the at least one stream outage; and providing at least one facility for transition from a first live source to a second live source in the same stream.

### PRIORITY CLAIM

This application claims the benefit of U.S. Provisional Application No. 62/409,253, filed Oct. 17, 2016; the contents of which are hereby incorporated by reference in its entirety as if fully set forth herein.

### COPYRIGHT NOTICE

This disclosure is protected under United States and/or International Copyright Laws.© 2017 Hubtag, LLC. All Rights Reserved. A portion of the disclosure of this patent document contains material that is subject to copyright protection. The copyright owner has no objection to the facsimile reproduction by anyone of the patent document or the patent disclosure, as it appears in the Patent and/or Trademark Office patent file or records, but otherwise reserves all copyright rights whatsoever.

### BRIEF DESCRIPTION OF THE DRAWINGS

FIG. 1 illustrates a conventional content and advertisement delivery model.

FIG. 2 illustrates one embodiment of the invention used for advertisement insertion.

FIG. 3 illustrates, generally, a conventional method for video transcoding for all purposes, along with a rough cost figure.

FIG. 4 illustrates one embodiment of the invention used for splicing, along with a rough cost figure.

### DETAILED DESCRIPTION

This application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms. In addition, the headings in this application are for reference purposes only and shall not in any way affect the meaning or interpretation of the present invention.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that performs particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

### Introduction.

One or more embodiments generally relate to video content distribution and entertainment. Embodiments of the invention provide the user with a low-cost solution for providing the service of combing live video streams with either live or static video streams in real time with little to no impact on quality and minimal impact on latency. Embodiments of the invention, either independently or working together, include a method for splicing video content from multiple sources into a single output stream without the need to transcode in real-time; detecting stream outages and automatically addressing them; and/or providing facilities to transition from one live source to another in the same stream. Other optionally advantageous features of embodiments of the invention include, but are not limited to, capturing a certain amount of video on a service and accessing it immediately on-demand; detecting problems with stream audio and/or video and providing useful alerts and/or attempts to compensate for them, if and/or when possible; and/or automatically providing bitrate padding to a live stream.

Conventional approaches currently employed in the field involve the computationally expensive technique of performing a complete video transcode in real time. These conventional approaches can require vast server resources and cost dollars per hour for every user just to operate and maintain. Thus, conventional methods for inserting video content could be cost prohibitive. Additionally, real time video transcoding can cause a very noticeable and negative impact on perceptual quality of video content and an increase in delivery latency of almost 10 seconds. Both of these are undesirable in modern applications. Users often pay hundreds of dollars a month and suffer lower quality video content.

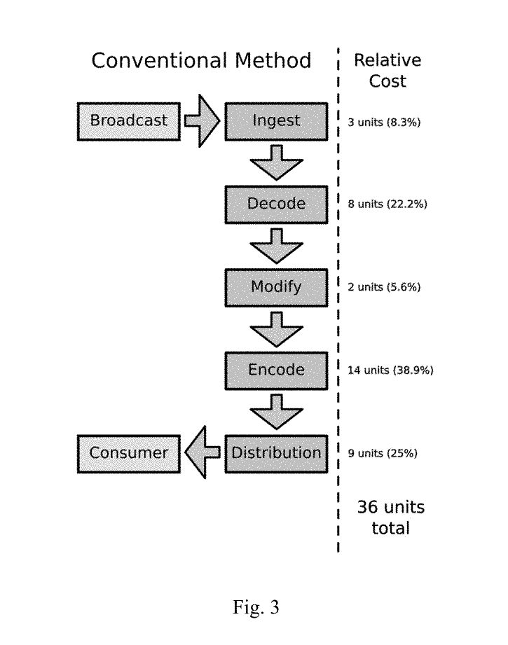

For example, FIG. 3 illustrates a rough flow of a conventional transcoding process, along with the relative cost of the process. As illustrated in FIG. 3, the costs of all steps are close to linearly proportional to the quality of the stream.

Prior to embodiments of the invention, there was no existing service that provided a zero-transcode method for combining multiple live or static video sources into a single live stream. Embodiments provide the user with the ability to splice video content directly into a livestream without the need for transcoding. Embodiments of the invention significantly decrease the cost of certain modifications to a live stream, both in computational resources required to perform the modification as well as the impact on audiovisual fidelity of the stream.

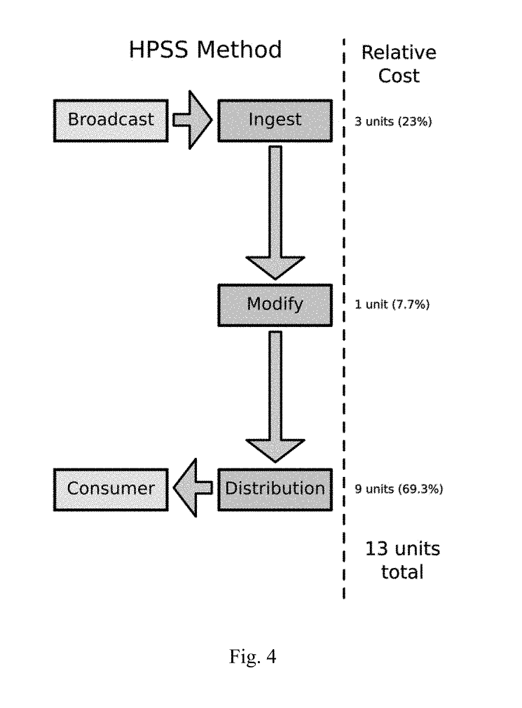

FIG. 4 illustrates a rough flow of one embodiment of the invention, along with the relative cost of the process. As illustrated in FIG. 4, the costs of all steps are close to linearly proportional to the quality of the stream.

A majority of everyday Internet traffic comprises the delivery of online video content. Historically, most video content that was viewed was static content that was pre-recorded, as real-time content was prohibitively expensive to produce or receive. In the past few years, live streaming has seen a massive growth in both production and viewership. There are various challenges related to this new form of content delivery though, as the real-time constraint makes it very difficult to perform complex actions on the video streams.

A video is essentially a series of images displayed in succession with very small time intervals along with audio tracks. Transmitting a video means transmitting all the images within the video, which can take up a lot of bandwidth. Video compression technologies can be used to compress the video down to a much smaller size without losing much visual fidelity. As compression technology has progressed, the complexity and fragility of compressed video streams has made the process of directly manipulating compressed video streams more and more difficult and non-obvious. As a result, most applications that modify compressed video will first decompress the video, modify it, and then compress it again. This has a very high cost in terms of computation, latency, and visual fidelity, as any slight artifacts left from the original encoding will be recoded and the visual impact will have compounded exponentially.

Embodiments of the invention provide the user with the ability to splice video content directly into a live media stream, carried through a protocol such as Real-Time Messaging Protocol (RTMP), without the need for transcoding. Among other things, this allows a user to inject advertisements or pre-made videos. Commercial applications include but are not limited to broadcast reliability, fast high quality video insertion, and end user cloud integration. Preferred embodiments of the invention include advertisement injection servers, instant replay clip providers, broadcast problem detection, and bitrate padding services. Embodiments of the present invention use a low-level understanding of audio and/or video delivery with the technology for real time post processing of live streams for various purposes.

### Preferred Embodiment

In a preferred embodiment, the invention acts as an active proxy service for RTMP streams carrying Advanced Video Coding (AVC) and Advanced Audio Coding (AAC)/MP3 data, which are the data formats being operated by the vast majority of streaming services. Other data formats are also compatible with the invention. The proxy services of the preferred embodiment of the invention can transparently pass RTMP streams through to a destination server, which may be specified in different ways based on the mode of operation. The forwarding destination may be (i) a fixed location, for example, in a reverse proxy situation; (ii) controlled by a management service, for example, for general purpose multi-destination streaming; and/or (iii) controlled by passing the desired RTMP destination through the playpath.

An optionally advantageous feature of the preferred embodiment is its ability to provide insurance services. The proxies can maintain a tunable delay buffer. In this embodiment, the delay should be the around the time it takes to determine a connection failure. If the delay is too short, the stream may appear to freeze prior to the insurance scene taking over. In a preferred embodiment, the optimal delay buffer is one second. However, other times such as a quarter to half of a second may also be tolerable. Finally, if insurance is not desired, then a delay of zero seconds can also be used.

In a preferred embodiment, when the user is ready for another source to be spliced into the stream—for example, an advertisement, insurance scene, or alternate stream—the proxy will seek for the beginning of a Network Abstraction Layer (NAL) packet in the current source stream's AVC stream, and will insert an the earliest available i-frame packet from the new stream. The new audio stream will have its timestamps adjusted to match any induced offset in the video. The original source is then effectively discarded. Through this method, embodiments of the present invention can seamlessly splice compatible AVC streams together. To obtain a compatible AVC stream, the proxy can, for example, keep a record of the metadata for the first source that it receives on a given playpath. Any videos that are likely to be spliced into the stream, such as the insurance scene, are transcoded to these specifications upon the initial connection, if they are not already available in the necessary format. Attempts to splice in a live stream can fail if the AVC streams do not match.

In another embodiment, the proxy may be forced to restart the stream to conform to a new, incompatible source, which is attempting to splice into the stream. Under standard conventional operation, if the proxy is in stream insurance mode, then the proxy will restart the stream to accommodate any new and incompatible live stream that is being sent through the server. Otherwise, the stream will be rejected. Users utilizing embodiments of the invention, however, may have the ability to negotiate with the proxy to automatically adjust themselves to emit compatible video, or even prompt the user about whether the stream should be restarted to accommodate the new format. Specific behavior can also be configurable by the server operator or a connected management service.

A cost comparison between similar services in the prior art highlights the optionally advantageous cost saving aspects of the preferred embodiment. The hard cost to implement one embodiment of the invention on a full HD stream would be under one cent an hour. To get a similar feature set on other services would cost at minimum 80 cents an hour. These numbers also discount the cost of bandwidth, as that is a constant factor and does not apply in all use cases.

### Non-Exhaustive Example Applications.

Broadcast Insurance. For those service providers that inspect the stream as it passes through the servers, the inventive technology can be used to detect the health of the streams running through the servers. In the example, the user can, via the invention, splice directly into a stream that has either crashed, or run dry and is dropping frames. In such an event, the user via the invention can display a predetermined scene that exists purely on the servers (the “insurance scene”) while the broadcaster troubleshoots their broadcast. The insurance scene will play for as long as the streamer is disconnected, up until either the streamer reconnects, tells the server to stop the stream, or a pre-determined amount of time has passed. The broadcaster is able to customize what appears in their insurance scene and how long it should last.

The broadcaster will no longer lose its audience by going offline. One skilled in art would appreciate that being offline for even a few seconds, let alone a minute, could be detrimental to viewership. The invention can allow broadcasters to restart or troubleshoot mid-stream, as a video advertisement or other asset plays from the servers of the service provider, during which the broadcasters can make whatever changes necessary to bring it back online.

Video Advertisement Technology for Platforms. In this example, because the invention provides the ability to modify a RTMP stream without the need for transcoding, the user is able to insert video advertisements with nearly zero additional delay and CPU time. This feature would be optionally advantageous for social platforms, such as Twitch, Facebook, and YouTube, due to the advertising network that can be created.

Furthermore, via one or more embodiments, a video advertisement can be inserted as part of the live stream itself. In this example, when the content reaches the consumer, advertising blocking software cannot distinguish the inserted advertisement from the normal stream. Global video advertisement will then be seen by all viewers, regardless of whether or not they are running advertising blocking software.

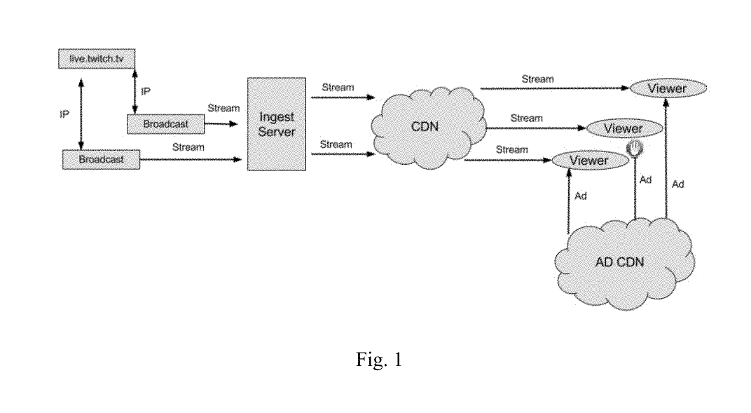

FIG. 1 illustrates one method of conventional content and advertisement delivery model. With conventional methods, live stream distributors deliver the content and advertisements from different locations, making it very simple for advertisement blocking software to discard any advertisements.

This feature will allow, for example, platforms to tap into markets that are currently inaccessible due to advertisement blockers. With millennials being one of the primary consumers of video content, and one of the biggest users of advertising blocking software, there is a lot of potential revenue that can be brought into these platforms without the need to grow their existing market.

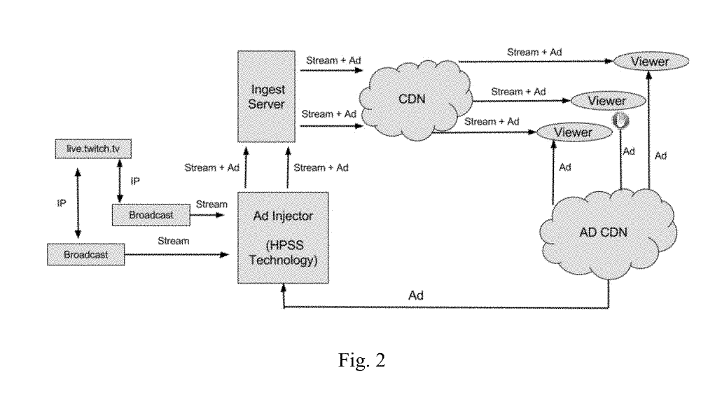

For example, FIG. 2 illustrates one embodiment of the invention that provides advertisement insertion. With this embodiment, advertisements can be inserted into the content of a live stream directly, so if advertisement blocking software discards an advertisement as seen in FIG. 1, the viewer must still view the advertisement in the content.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

We claim:

1. A method, comprising the steps of:
splicing video content from at least one source into a single output stream without transcoding the video content in real-time;
detecting at least one stream outage;
addressing the at least one stream outage; and
providing at least one facility for transition from a first live source to a second live source in the same stream.

2. The method of claim 1, wherein the step of addressing is automatic.

3. The method of claim 1, further comprising the steps of capturing a certain amount of video on a service and accessing said video immediately on demand.

4. The method of claim 1, further comprising the steps of detecting at least one problem with the stream and providing an alert.

5. The method of claim 4, wherein the problem is audio or visual.

6. The method of claim 4, further comprising the step of compensating for the problem.

7. The method of claim 1, further comprising the step of providing bitrate padding to a live stream.

8. The method of claim 7, wherein the providing is automatic.
